(19) United States
(12) Patent Application Publication
(10) Pub. No.: US 2026/0004957 A1
(43) Pub. Date: Jan. 1, 2026

(54) FLAT WIRING MEMBER HOLDING MEMBER AND WIRING MODULE

(71) Applicants: Sumitomo Wiring Systems, Ltd., Mie (JP); TOYOTA JIDOSHA KABUSHIKI KAISHA, Aichi (JP)

(72) Inventors: Kengo OKADA, Mie (JP); Atsushi KURODA, Mie (JP); Junya YONEKAWA, Mie (JP); Koichi YAMAGA, Mie (JP); Masataka YAMAUCHI, Mie (JP); Akinori ISHIKAWA, Aichi (JP); Mitsuhiro KATO, Aichi (JP)

(73) Assignees: Sumitomo Wiring Systems, Ltd., Mie (JP); TOYOTA JIDOSHA KABUSHIKI KAISHA, Aichi (JP)

(21) Appl. No.: 19/245,838

(22) Filed: Jun. 23, 2025

(30) Foreign Application Priority Data
Jun. 28, 2024 (JP) 2024-105042

(51) Int. Cl. H01B 17/14

(52) U.S. Cl. CPC H01B 17/14

(57) ABSTRACT

A flat wiring member holding member is a flat wiring member holding member holding a flat wiring member, including: a holding base including a base body and a locking part; and a press part including a press body disposed to face the base body and a counterpart locking part locked to the locking part. The flat wiring member is disposed between the base body and the press body while the locking part is locked to the counterpart locking part. The press part includes an elastic press piece protruding to a side of the base body from the press body to elastically press the flat wiring member toward the base body.

### BACKGROUND

### Technical Field

The present disclosure relates to a flat wiring member holding member and a wiring module.

### Description of the Background Art

International Publication No. 2020/178998 discloses a hinge-pivoting clamp. In this clamp, two partial annular parts constituting annular parts are connected by a hinge part. A locking protrusion is provided to an end part of one partial annular part in a longitudinal direction, and a locking receiving part is formed in an end part of the other partial annular part in the longitudinal direction. The locking protrusion is locked to the locking receiving part, and the annular part sandwiches an extension piece.

### SUMMARY

It is desired that a flat wiring member can be firmly held regardless of change of a thickness of the flat wiring member.

Accordingly, an object of the present disclosure is to be able to firmly hold a flat wiring member regardless of change of a thickness of the flat wiring member.

A flat wiring member holding member according to the present disclosure is a flat wiring member holding member holding a flat wiring member, including: a holding base including a base body and a locking part; and a press part including a press body disposed to face the base body and a counterpart locking part locked to the locking part, wherein the flat wiring member is disposed between the base body and the press body while the locking part is locked to the counterpart locking part, and the press part includes an elastic press piece protruding to a side of the base body from the press body to elastically press the flat wiring member toward the base body.

A wiring module according to the present disclosure is a wiring module including: the flat wiring member holding member described above; and a flat wiring member, wherein the elastic press piece presses a part of the flat wiring member located between the base body and the press body toward the base body.

According to the present disclosure, a flat wiring member can be firmly held regardless of change of a thickness of the flat wiring member.

These and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a perspective view illustrating a wiring module according to an embodiment 1.

FIG. 2 is a perspective view illustrating a flat wiring member holding member.

FIG. 3 is a perspective view illustrating the flat wiring member holding member.

FIG. 4 is a plan view illustrating the flat wiring member holding member.

FIG. 5 is a cross-sectional view along a V-V line in FIG. 1.

FIG. 6 is a perspective view illustrating the flat wiring member holding member.

FIG. 7 is a cross-sectional view illustrating a wiring module.

### DESCRIPTION OF THE PREFERRED EMBODIMENTS

### Description of Embodiments of Present Disclosure

Embodiments of the present disclosure are listed and described firstly.

A flat wiring member holding member according to the present disclosure is as follows.
(1) A flat wiring member holding member is a flat wiring member holding member holding a flat wiring member, including: a holding base including a base body and a locking part; and a press part including a press body disposed to face the base body and a counterpart locking part locked to the locking part, wherein the flat wiring member is disposed between the base body and the press body while the locking part is locked to the counterpart locking part, and the press part includes an elastic press piece protruding to a side of the base body from the press body to elastically press the flat wiring member toward the base body.

According to the flat wiring member holding member, the elastic press piece is deformed in accordance with a thickness of the flat wiring member and elastically presses the flat wiring member toward the base body. Accordingly, the flat wiring member can be firmly pressed against the base body and held regardless of the thickness of the flat wiring member.
(2) In the flat wiring member holding member according to (1), it is applicable that the locking part is a through locking part protruding from the base body, the through locking part is locked to the counterpart locking part while passing through the flat wiring member, and the flat wiring member is disposed between the base body and the press part.

In this case, the through locking part is locked to the counterpart locking part while passing through the flat wiring member, and sandwiches the flat wiring member between the base body and the press part. Thus, even when a shape of the flat wiring member is changed, the flat wiring member can be easily held.
(3) In the flat wiring member holding member according to (2), the elastic press piece may be disposed in a position closer to an edge of the flat wiring member than the through locking part is.
(4) In the flat wiring member holding member according to (2) or (3), it is applicable that the elastic press piece includes a base end continuously formed with the press body and a distal end located closer to the through locking part than the base end is, and the elastic press piece includes a part extending to protrude from the press body with a larger degree as getting closer to the distal end from the base end.

In this case, the flat wiring member can be pressed toward the base body at a part of the elastic press piece close to the through locking part, and the flat wiring member can be firmly held.
(5) The flat wiring member holding member according to any one of (1) to (4) may further include a hinge openably and closably connecting the base body and the press part.

Accordingly, the base body and the press part can be integrally and easily handled.
(6) In the flat wiring member holding member according to any one of (1) to (5), a part of the elastic press piece having contact with the flat wiring member may be formed into a curved shape.

In this case, since the part of the elastic press piece formed into the curved shape has contact with the flat wiring member, a curved surface can smoothly slide on the flat wiring member when the elastic press piece presses the flat wiring member.
(7) In the flat wiring member holding member according to any one of (1) to (6), it is applicable that the press body includes a through opening, and the elastic press piece is located inside the through opening in a plan view.

In this case, the elastic press piece can be elastically deformed using a space in the through opening. Thus, a space in which the elastic press piece can be deformed is easily ensured while the flat wiring member holding member is thinned.
(8) In the flat wiring member holding member according to any one of (1) to (7), a natural protrusion length of the elastic press piece with respect to the press body may be a length such that the elastic press piece reaches a holding surface of the base body while the locking part is locked to the counterpart locking part.

In this case, the elastic press piece can press the flat wiring member against the base body more reliably while the locking part is locked to the counterpart locking part.
(9) In the flat wiring member holding member according to any one of (1) to (8), a fixing part fixed to a fixation target may protrude from the base body.

In this case, the flat wiring member can be held based on the base body of the holding base fixed to the fixation target via the fixing part.

A wiring module according to the present disclosure is as follows.
(10) A wiring module includes: the flat wiring member holding member according to any one of (1) to (9); and a flat wiring member, wherein the elastic press piece presses a part of the flat wiring member located between the base body and the press body toward the base body.

In this case, the flat wiring member is firmly held by the flat wiring member holding member.

### DETAILED DESCRIPTION OF EMBODIMENT OF PRESENT DISCLOSURE

Specific examples of a wiring module of the present disclosure are described hereinafter with reference to the diagrams. The present disclosure is not limited to these exemplifications, but is indicated by claims, and it is intended that meanings equivalent to claims and all modifications within a scope of claims are included.

### Embodiment 1

A flat wiring member holding member and a wiring module according to an embodiment 1 are described hereinafter.

### <Wiring Module>

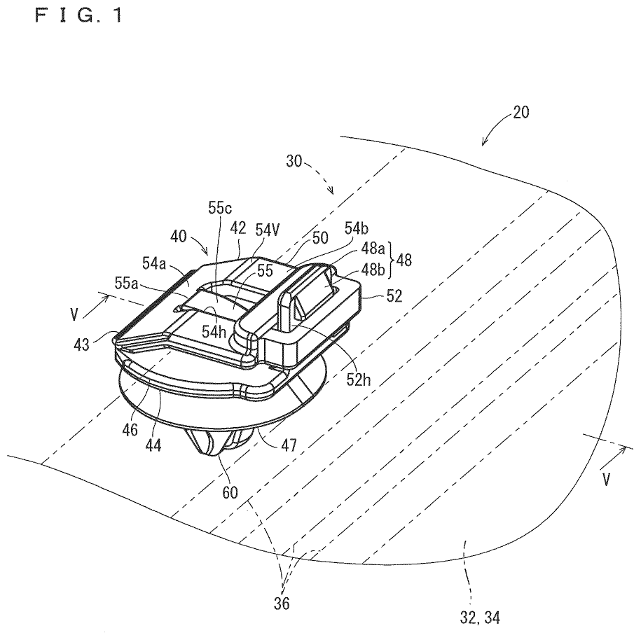

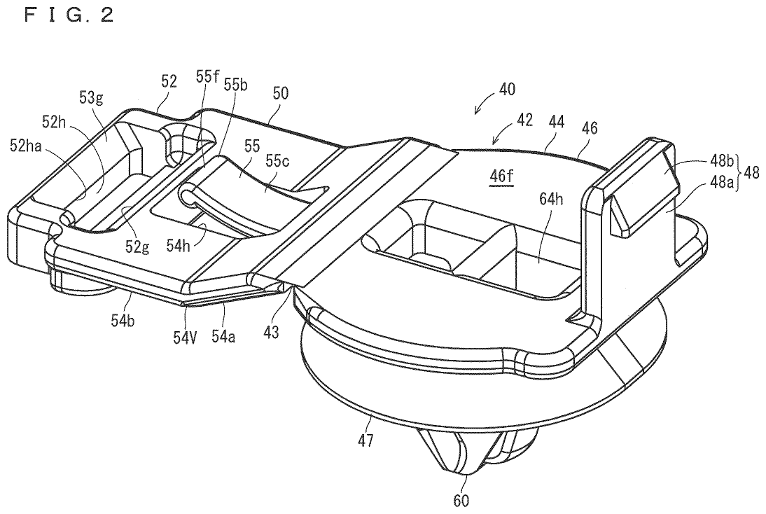

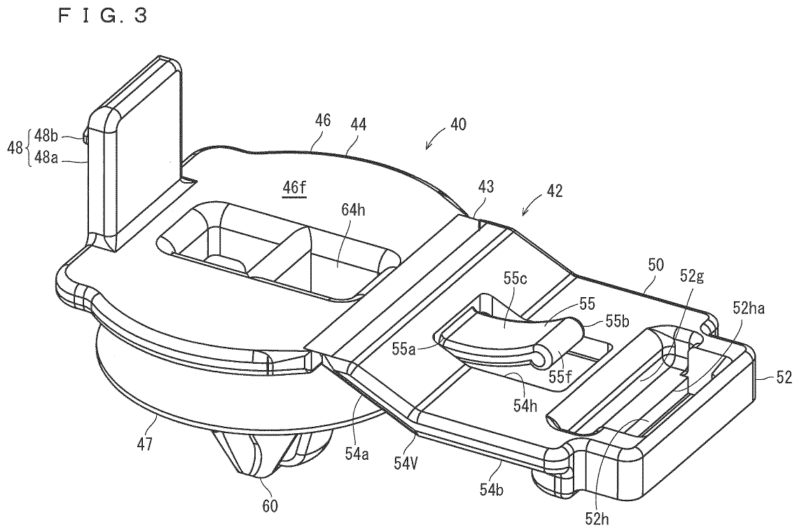

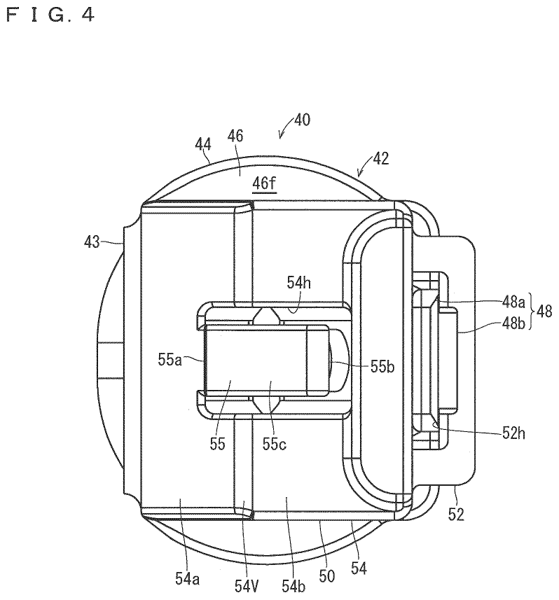

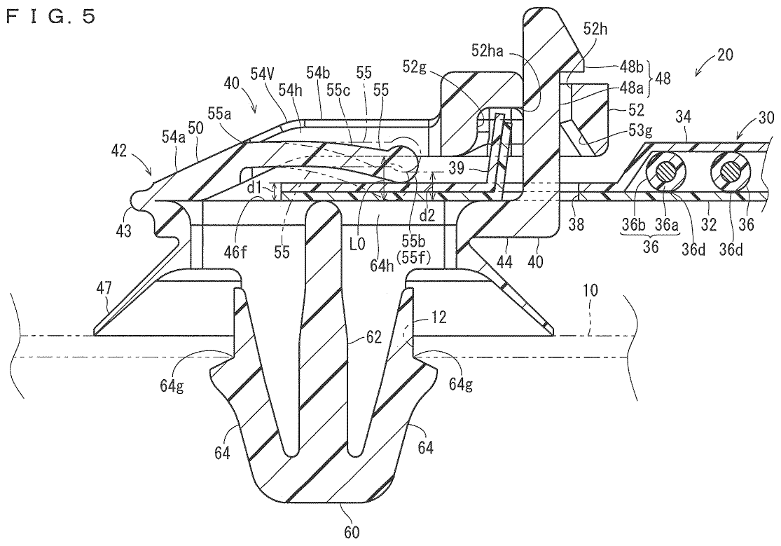

FIG. 1 is a perspective view illustrating a wiring module 20. FIG. 1 illustrates a flat wiring member 30 by a dash-double-dot line. FIG. 2 and FIG. 3 are perspective views each illustrating a flat wiring member holding member 40. FIG. 4 is a plan view illustrating the flat wiring member holding member 40. FIG. 5 is a cross-sectional view along a V-V line in FIG. 1.

The wiring module 20 includes the flat wiring member holding member 40 and the flat wiring member 30.

The flat wiring member 30 is a flat wiring member including a circuit for wiring. The flat wiring member holding member 40 is a component holding the flat wiring member 30. When the flat wiring member holding member 40 is fixed to a fixation target 10 while holding the flat wiring member 30, a holding part of the flat wiring member 30 is supported at a predetermined position in the fixation target 10.

### <Flat Wiring Member>

An example of the flat wiring member 30 is described. The flat wiring member 30 is a member mounted to a vehicle to serve as a power supply path supplying electrical power to each apparatus, a ground path, or a transmission path of a signal. The flat wiring member 30 has a dimension in a thickness direction smaller than a dimension in a width direction perpendicular to the thickness direction. The flat wiring member 30 includes a base member 32 and a plurality of wire-like transmission members 36. The plurality of wire-like transmission members 36 are supported along the base member 32, thus are supported to be flatly arranged.

The wire-like transmission member 36 may be a wire-like member transmitting electricity or light, for example. For example, the wire-like transmission member 36 may be a general wire having a core wire and a covering around the core wire, or may also be a bare conductive wire, a shielded wire, an enamel wire, a nichrome wire, or an optical fiber.

The wire-like transmission member 36 transmitting the electricity may be various kinds of signal lines or various kinds of power lines. The wire-like transmission member 36 transmitting the electricity may be used as an antenna or coil, for example, transmitting or receiving a signal or electrical power to or from a space.

The wire-like transmission member 36 includes a transmission wire body 36a transmitting electricity or light and a covering 36b covering the transmission wire body. When the wire-like transmission member 36 is a general wire, the transmission wire body is a core wire, and the covering is an insulating covering. The plurality of wire-like transmission members 36 may have the same thickness and structure. The plurality of wire-like transmission members 36 may have different thicknesses and structures.

The wire-like transmission member 36 may be a single wire-like object or a composite object of a plurality of wire-like objects (a twisted wire and a cable made up of a plurality of wire-like objects covered by a sheath). A terminal and a connector, for example, are appropriately provided in accordance with a connection state of the wire-like transmission member 36 and a counterpart member in an end part of the wire-like transmission member 36.

The base member 32 holds the plurality of wire-like transmission members 36 in a state of being arranged side by side. Herein, the base member 32 is a sheet molded separately from the wire-like transmission member 36. The wire-like transmission member 36 is disposed along a predetermined route on a main surface of the base member 32 formed into a sheet-like shape.

The plurality of wire-like transmission members 36 may be fixed to only one main surface of the base member 32, or may also be fixed to both surfaces thereof.

The base member 32 is formed into a shape corresponding to a wiring route of the wire-like transmission member 36. For example, the base member 32 may be formed into an elongated rectangular shape. The base member 32 may be formed into a shape curved midway in a width direction. The plurality of wire-like transmission member 36 may be fixed to the base member 32 along a branched route. In this case, the base member 32 may be formed into a shape branched in accordance with the branched route.

A material constituting the base member 32 is not particularly limited. However, the base member 32 is formed of a material containing resin of polyvinyl chloride (PVC), polyethylene terephthalate (PET), or polypropylene (PP), for example. The base member 32 may be a fibrous material having fiber such as a non-woven cloth, a woven fabric, or a knitting fabric or a non-fiber material, for example. The non-fiber material may be a solid member with an inner part evenly filled or a foam made up by foam molded resin. The base member 32 may contain a material such as metal.

The base member 32 may be made up of a single layer or a plurality of stacked layers. When the base member 32 is made up of the plurality of stacked layers, it is considered that a resin layer and a resin layer are stacked, for example. It is also considered that a resin layer and a metal layer are stacked, for example. The base member 32 may be made up of a non-fiber material layer and a non-fiber material layer overlapped with each other, a non-fiber material layer and a fiber material layer overlapped with each other, or a fiber material layer and a fiber material layer overlapped with each other.

The base member 32 may be a bendable member, a member having rigidity with a degree of being able to be curved and hold the plurality of wire-like transmission members 36 in a state of being planarly positioned, or a member having rigidity with a degree of being able to keep itself in a flat state and hold the plurality of wire-like transmission members 36 in a state of being two-dimensionally positioned. The base member 32 may have a three-dimensional shaped part such as a part made up of a wall partially standing on the base member 32.

The wire-like transmission member 36 is fixed to the base member 32. Applicable as the above fixing state are a contact area fixation and a non-contact area fixation, or both fixations may be used together. Herein, the contact area fixation indicates that a part where the wire-like transmission member 36 and the base member 32 have contact with each other is stuck and fixed. The non-contact area fixation indicates the fixing state which is not the contact area fixation. For example, a sewing thread, the other base material, or an adhesive tape presses the wire-like transmission member 36 toward the base member 32, or surrounds and sandwiches the wire-like transmission member 36 and the base member 32 to keep them in a fixing state. In the description hereinafter, the wire-like transmission member 36 and the base member 32 are in the state of the contact area fixation. Each description on the contact area fixation is also applicable to the non-contact area fixation as long as each member and material has a configuration to which the non-contact area fixation is not applicable.

Applicable as the configuration of the contact area fixation are an indirect fixation and a direct fixation, or both fixations may also be used together in different regions. Herein, the indirect fixation indicates that the wire-like transmission member 36 and the base member 32 are indirectly stuck and fixed via an intervening object such as an adhesive agent, a gluing agent, a double-sided adhesive tape, and a hook and loop fastener provided therebetween. The direct fixation indicates that the wire-like transmission member 36 and the base member 32 are directly stuck and fixed without an intervention of the adhesive agent, for example, which is separately provided. Considered in the direct fixation is that resin included in at least one of the wire-like transmission member 36 and the base member 32 is melted, thus the wire-like transmission member 36 and the base member 32 are stuck and fixed, for example. In the description hereinafter, the wire-like transmission member 36 and the base member 32 are in the state of the direct fixation. Each description on the direct fixation is also applicable to the indirect fixation as long as each member and material has a configuration to which the indirect fixation is applicable.

In forming the state of such a direct fixation, the resin is considered to be melted by heat or a solvent, for example. That is to say, the state of the direct fixation may be the state of the direct fixation by the heat or the state of the direct fixation by the solvent. The direct fixation by the heat is preferable.

At this time, a means of forming the state of the direct fixation is not particularly limited, but various means including a known means such as welding, fusion, and melting joint can be used. For example, when the state of the direct fixation by the heat is formed by welding, various welding means such as ultrasonic welding, heating-pressurizing welding, hot air welding, and high frequency welding can be adopted. When the state of the direct fixation is formed by these means, the wire-like transmission member 36 and the base member 32 are in the state of the direct fixation by these means. Specifically, when the state of the direct fixation is formed by the ultrasonic welding, for example, the wire-like transmission member 36 and the base member 32 are in the state of the direct fixation by the ultrasonic welding. A portion where the state of the direct fixation by the heat is formed by the welding (a fixing portion between the wire-like transmission member 36 and the base member 32) may be referred to as a welding part, and herein, the fixing portion by the ultrasonic welding may be referred to as an ultrasonic welding part, and the fixing portion by the heating-pressurizing welding may be referred to as a heating-pressurizing welding part, for example.

In the case of the direct fixation, only the resin included in the covering of the wire-like transmission member 36 may be melted, or only the resin included in the base member 32 may be melted. In these cases, the resin which has been melted is stuck on an outer surface of the resin on the other side, and a relatively clear interface may be formed in some cases. In the case of the direct fixation, both the resin included in the covering of the wire-like transmission member 36 and the resin included in the base member 32 may be melted. In this case, there may be a case where the resin in both the components are mixed and a clear interface is not formed. Particularly, when the covering of the wire-like transmission member 36 and the base member 32 include compatible resin such as the same resin material, for example, there may be a case where both the resins are mixed and a clear interface is not be formed.

In the present embodiment, the wire-like transmission member 36 is fixed to the base member 32 via a fusion part 36d by contact area fixation and direct fixation, that is to say, contact area direct fixation.

The flat wiring member 30 may include a cover 34. The cover 34 is fixed to the base member 32 to cover the wire-like transmission member 36.

The cover 34 is a sheet molded separately from the wire-like transmission member 36, for example. A material constituting the cover 34 is not particularly limited. However, the cover 34 may be formed of a material containing resin of polyvinyl chloride (PVC), polyethylene terephthalate (PET), or polypropylene (PP), for example, in the manner similar to the base member 32. The cover 34 may be a fibrous material having fiber such as a non-woven cloth, a woven fabric, or a knitting fabric or a non-fiber material, for example, in the manner similar to the base member 32.

It is applicable that the cover 34 has the same shape as the base member 32, spreads over a larger area than the base member 32, or has a size small enough to be housed in the base member 32. In the present embodiment, the cover 34 is formed into the same shape as the base member 32, and is stacked to the base member 32 while both side edges of the cover 34 are disposed along both side edges of the base member 32.

A fixing structure of fixing the cover 34 to the base member 32 is not particularly limited. For example, the cover 34 may be fused and fixed to the base member 32. The fusion fixation may be performed by ultrasonic welding, heating pressurizing welding, hot air welding, or high-frequency welding. The cover 34 may be fixed to the base member 32 by an adhesive agent, a double-sided adhesive tape, or sewing, for example.

The cover 34 is fixed to the base member 32 at both outer regions located outside a region where the plurality of wire-like transmission members 36 are arranged. That is to say, both side parts of the cover 34 are fixed to both side parts of the base member 32. The plurality of wire-like transmission members 36 are disposed side by side between the base member 32 and the cover 34 between the fixing positions on both sides. The cover 34 is not directly fixed to the plurality of wire-like transmission members 36.

A through hole 38 is formed in the flat wiring member 30. The through hole 38 is a hole formed to be held by the flat wiring member holding member 40.

The through hole 38 is formed in an outer region of the plurality of wire-like transmission members 36 in the base member 32. In the present embodiment, the cover 34 is stacked and bonded to both outer regions in the base member 32. Thus, the through hole 38 is formed to pass through the base member 32 and the cover 34. The through hole 38 is formed into a quadrangular shape, for example. The through hole 38 may be formed into the other shape such as a circular shape, an oval shape, or polygonal shape, for example.

The flat wiring member 30 may include a leftover tongue piece 39 extending from a peripheral edge of the through hole 38. The leftover tongue piece 39 is a part which has spread over a region in the through hole 38 in the base member 32 and the cover 34.

For example, the through hole 38 is formed by partially punching the base member 32 and the cover 34 by a punching blade. When a punched part is completely cut from the base member 32 and the cover 34, scrap occurs by the punched part, and it takes labor for scrap disposal. Thus, when the through hole 38 is formed, a surrounding part of the through hole 38 is partially punched, and a remaining part is left as it is. Then, the part spreading in the through hole 38 is left while being connected to the base member 32 or the cover 34 in a part of the peripheral edge of the through hole 38. This part is the leftover tongue piece 39. For example, the leftover tongue piece 39 is separated from the base member 32 or the cover 34 at three sides of the quadrangular through hole 38, and is left while being connected to the base member 32 or the cover 34 at the other one side. The other one side is a side located close to the side edge of the base member 32 in the peripheral edge of the through hole 38, for example.

When the leftover tongue piece 39 is bended at a base end part, the through hole 38 can be opened. The leftover tongue piece 39 can be left while being connected to a part of the peripheral edge of the through hole 38 in the state where the through hole 38 is opened. Thus, scrap disposal caused by punching needs not be performed.

Since the cover 34 covers the base member 32 in the present embodiment, the leftover tongue piece 39 has a two-piece structure of a part corresponding to the base member 32 and a part corresponding to the cover 34. When the cover 34 is omitted, the leftover tongue piece 39 has a single-piece structure corresponding to the base member 32.

The flat wiring member 30 is not limited to the above configuration. The flat wiring member 30 may be kept in a flat state so that a plurality of wire-like conductors are insulated from each other by an insulating member such as a flexible printed circuit (EPC) or a flexible flat cable (FFC), for example. That is to say, the flat wiring member may be a wiring member in which transmission mediums including a plurality of wire-like conductors are held in a flat form while being insulated from each other and formed so that a thickness thereof is smaller than a width thereof as a whole.

### <Flat Wiring Member Holding Member>

The flat wiring member holding member 40 is a component holding the flat wiring member 30. The flat wiring member 30 may be a component integrally molded by the same resin.

The flat wiring member holding member 40 includes a holding part 42 with a holding base 44 and a press part 50.

The holding base 44 includes a base body 46 and a through locking part 48 as a locking part.

The base body 46 is formed into a shape having a holding surface 46f such as a plate-like shape, for example. The plate-like shape of the base body 46 is optionally determined. For example, an oval shape, a circular shape, or a quadrangular shape is also applicable. In the present embodiment, the base body 46 is formed into an oval plate-like shape. The holding surface 46f is formed into a planar surface.

The through locking part 48 protrudes from the holding surface 46f of the base body 46. The protrusion direction of the through locking part 48 is a direction perpendicular to the holding surface 46f. A position of the through locking part 48 is a position close to one end of the holding surface 46f, for example.

The press part 50 is a part sandwiching the flat wiring member 30 with the base body 46. The press part 50 includes a press body 54 and a counterpart locking part 52. The press body 54 is a part disposed to face the base body 46. The counterpart locking part 52 is a part to which the through locking part 48 is locked. The through locking part 48 is inserted into the through hole 38 of the flat wiring member 30 while the flat wiring member 30 is disposed on the holding surface 46f. The through locking part 48 protrudes above the flat wiring member 30. The press body 54 is disposed on a position in the holding surface 46f of the base body 46 to face the base body 46 via the flat wiring member 30. In this state, the through locking part 48 is locked to the counterpart locking part 52. Then, the flat wiring member 30 is disposed between the base body 46 and the press part 50.

The press part 50 includes an elastic press piece 55. The elastic press piece 55 can elastically press the flat wiring member 30 toward the base body 46 while the flat wiring member 30 is disposed between the base body 46 and the press part 50.

The holding part 42 may include a hinge 43 openably and closably connect the base body 46 and the press part 50. The hinge 43 is a part connecting a part of the base body 46 on a side opposite to the through locking part 48 and an end part of the press part 50. The hinge 43 is a resin part formed to be thinner than the base body 46 and the press part 50 so as to be able to be deformed.

The press part 50 can openably and closably change a posture around the hinge 43 with respect to the base body 46. A position where the press part 50 faces the holding surface 46f of the base body 46 is a close position. A position where the press part 50 is rotationally moved around the hinge 43 to retract from the position facing the holding surface 46f is an open position.

Also applicable is a structure that the press part and the base body are components prepared as different components and incorporated by locking the through locking part 48 and the counterpart locking part 52. In this case, the holding part may have a plurality of combinations of the through locking hole and the counterpart locking part.

In the present embodiment, the flat wiring member holding member 40 further includes a fixing part 60.

The fixing part 60 protrudes from the base body 46. The fixing part 60 is a part fixed to the fixation target 10. The fixation target 10 is a part of a vehicle, for example.

For example, also applicable is a structure that the fixing part 60 includes a columnar part 62 and a locking piece 64.

The columnar part 62 is an elongated part, and protrudes from a part of the base body 46 on a side opposite from the holding surface 46f to a side opposite to the holding surface 46f. Since the locking piece 64 is molded in the present embodiment, an elongated opening 64h for molding is formed in a center of the base body 46. Both side parts of the base end part of the columnar part 62 is supported by an inner surface of the opening 64h at an intermediate position of the opening 64h in a longitudinal direction.

The pair of locking pieces 64 are supported to be elastically deformable on the columnar part 62. The pair of locking pieces 64 are located on opposite sides of the columnar part 62. That is to say, the columnar part 62 is located between the pair of locking pieces 64. The locking piece 64 extends from the distal end toward the base end of the columnar part 62 to be gradually away from the columnar part 62. The locking concave part 64g is formed in an outer side of the distal end of the locking piece 64.

A disc spring 47 is supported on the base body 46. The disc spring 47 extends to an outer side of the base end of the columnar part 62.

When the fixing part 60 is inserted into the fixing hole 12 of the fixation target 10, the pair of locking pieces 64 have contact with a peripheral edge of the fixing hole 12 and are elastically deformed in a direction getting closer to the columnar part 62. When the locking concave parts 64g of the pair of locking pieces 64 pass over the fixing hole 12, the pair of locking pieces 64 are elastically restored to have an original shape. Then, the locking concave parts 64g of the pair of locking pieces 64 are locked to the peripheral edge of the fixing hole 12 from a side opposite to the base body 46. The disc spring 47 has elastically contact with the fixation target 10 from a side of the base body 46 at the peripheral edge of the fixing hole 12. Accordingly, the fixation target 10 is sandwiched between the locking piece 64 and the disc spring 47 around the fixing hole 12, and the fixing part 60 is fixed to the fixation target 10.

The fixing part 60 described above may be formed in the press part 50.

The structure of the fixing part for fixation to the fixation target is not limited to the above example. For example, the fixing part may have a so-called tree-like clip structure or a structure of being fixed to a stud bolt fixed to a vehicle.

The fixing part for fixation to the vehicle may not be directly formed in the holding part. The holding part described above may be a part formed in various components fixed to the vehicle such as a protector for protecting an electrical wire, for example.

### <Sandwiching Structure>

A structure of holding part 42 sandwiching and holding the flat wiring member 30 is described more specifically.

As described above, the hinge 43 and the through locking part 48 are located in the end part on the opposite side of the base body 46.

The through locking part 48 includes a columnar part 48a protruding from the base body 46 and a locking convex part 48b protruding from the columnar part 48a.

The columnar part 48a is formed into a rectangular plate-like shape, for example. The columnar part 48a extends to be perpendicular to the holding surface 46f. A width direction of the columnar part 48a extends along a direction of a pivot axis of the press part 50 by the hinge 43.

The locking convex part 48b protrudes outside from one main surface of a distal end part of the columnar part 48a. The locking convex part 48b includes an inclination surface reducing a protrusion dimension of the locking convex part 48b toward a side of a distal end of the columnar part 48a. A surface of the locking convex part 48b directed to a side of the base end of the columnar part 48a is formed into a surface perpendicular to the columnar part 48a.

The locking convex part 48b preferably protrudes to a side opposite to a part of the peripheral edge of the through hole 38 with which the leftover tongue piece 39 is formed.

In the present embodiment, the leftover tongue piece 39 is continuously formed with the peripheral edge of the through hole 38 outside the base member 32 in the width direction. Thus, when the through locking part 48 passes through the through hole 38, the leftover tongue piece 39 is located closer to a side of the hinge 43 in relation to the columnar part 48a.

Thus, the locking convex part 48b is formed to protrude to a opposite side of the columnar part 48a from to the hinge 43. That is to say, the locking convex part 48b is locked to the counterpart locking part 52 of the press part 50 on a side opposite to the hinge 43.

As described above, the leftover tongue piece 39 and the locking convex part 48b are disposed on the opposite side of the columnar part 48a. Accordingly, the leftover tongue piece 39 hardly enters the locking part between the locking convex part 48b and the counterpart locking part 52, and the locking convex part 48b can be locked to the counterpart locking part 52 more reliably.

The press part 50 includes the press body 54 and the counterpart locking part 52.

The press body 54 is formed into a plate-like shape continuously formed with the base body 46 via the hinge 43. A bending part 54V may be located between a part of the press body 54 continuously formed with the hinge 43 and an end part of the press body 54 on a side opposite to the part thereof. It is also applicable that a part of the press body 54 closer to a base end in relation to the bending part 54V is an inclination part 54a and a part thereof closer to a distal end is a horizontal facing part 54b. It is also applicable that the inclination part 54a is inclined with respect to the holding surface 46f while the through locking part 48 is locked to the counterpart locking part 52, and the horizontal facing part 54b has a posture closer to a horizontal posture in relation to the holding surface 46f than the inclination part 54a. Accordingly, a gap where the flat wiring member 30 can be disposed can be ensured between the holding surface 46f and the horizontal facing part 54b.

The press part 50 includes the elastic press piece 55. The elastic press piece 55 protrudes from the press body 54 to a side of the base body 46 to elastically press the flat wiring member 30 toward the base body 46.

The elastic press piece 55 is located between the hinge 43 and the through locking part 48. A side part of the flat wiring member 30 and an edge of the side part are disposed between the holding base 44 and the press part 50. Thus, the elastic press piece 55 is disposed in a position closer to the edge of the flat wiring member 30 than the through locking part 48 is. Thus, the elastic press piece 55 can press the flat wiring member 30 from a side of the edge.

More specifically, the press body 54 includes the through opening 54h. The through opening 54h is a hole passing through the press body 54 in a thickness direction. The through opening 54h is formed in an intermediate part of the press body in a width direction. The through opening 54h is formed from a part of the inclination part 54a close to the bending part 54V to the horizontal facing part 54b through the bending part 54V.

The elastic press piece 55 is located inside the through opening 54h in a plan view along a direction perpendicular to the holding surface 46f. A base end 55a of the elastic press piece 55 is continuously formed with an edge of the through opening 54h on a side of the hinge 43. The elastic press piece 55 is formed to protrude from the base end 55a toward the through locking part 48. That is to say, a distal end 55b of the elastic press piece 55 is closer to the through locking part 48 than the base end 55a is. Both side surfaces and the distal end 55b of the elastic press piece 55 is separated from an inner peripheral edge of the through opening 54h. The elastic press piece 55 can be elastically deformed in the thickness direction of the press body 54 based on the base end 55a as a support position.

The elastic press piece 55 includes a part extending to protrude from the press body 54 to a side of the holding base 44 more as getting closer to the distal end 55b from the base end 55a. In the present embodiment, the whole intermediate part of the elastic press piece 55 located between the base end 55a and the distal end 55b is an intermediate inclination part 55c extending to protrude from the press body 54 to a side of the holding base 44 more as getting closer to the distal end 55b from the base end 55a. The intermediate inclination part 55c may be curved and inclined or inclined straight. In the present embodiment, the intermediate inclination part 55c is curved to be convexed on a side opposite to the holding surface 46f and is inclined to a side of the holding surface 46f. The whole intermediate part of the elastic press piece 55 needs not be the intermediate inclination part. For example, it is applicable that a part of the intermediate part of the elastic press piece is the intermediate inclination part and the other part thereof is a part parallel to the holding surface 46f. It is sufficient that the intermediate part of the elastic press piece 55 is formed to have a thickness of generating force appropriate to press the flat wiring member 30. For example, the intermediate part of the elastic press piece 55 may be formed to be thinner than the press body 54.

The press body 54 is directed to a side of the holding surface 46f as getting closer to the through locking part 48. Thus, the base end of the press body 54 is housed in the through opening 54h. The elastic press piece 55 protrudes to the side of the holding surface 46f from an inner side of the through opening 54h with a larger degree as getting closer to a side of the distal end. The elastic press piece 55 can be elastically deformed to change a protrusion dimension with respect to the press body 54 based on the base end thereof as a support position.

Since the distal end 55b of the elastic press piece 55 protrudes the most from the press body 54, the distal end 55b has contact with the flat wiring member 30 and presses the flat wiring member 30 against the holding surface 46f. A part of the elastic press piece 55 having contact with the flat wiring member 30 may be formed into a curved surface 55f having a curved-surface shape. In the present embodiment, the distal end 55b of the elastic press piece 55 is formed into a partially-circular columnar shape extending along a width direction of the elastic press piece 55. Thus, an outer surrounding surface of the distal end 55b of the elastic press piece 55 is formed into the curved surface 55f having a partially-outer surrounding shape of a circular column. The elastic press piece 55 can have contact with the flat wiring member 30 at the curved surface 55f. Thus, the elastic press piece 55 can smoothly slide on the upper surface of the flat wiring member 30 while pressing the flat wiring member 30 toward the holding surface 46f.

The press part 50 is disposed in the position facing the holding base 44 while the flat wiring member 30 is disposed on the holding surface 46f, and the through locking part 48 is locked to the counterpart locking part 52. At this time, the elastic press piece 55 is elastically deformed in accordance with the thickness of the flat wiring member 30. Thus, the elastic press piece 55 can press the flat wiring member 30 toward the holding surface 46f between the through locking part 48 and the hinge 43 regardless of the thickness of the flat wiring member 30.

A natural protrusion length L0 of the elastic press piece 55 with respect to the press body 54 may have a size such that the elastic press piece 55 reaches the holding surface 46f of the base body 46 while the through locking part 48 is locked to the counterpart locking part 52. The natural protrusion length L0 is a protrusion length of the elastic press piece 55 with respect to the press body 54 in a state where the press part 50 is located in an open position and the elastic press piece 55 does not press the flat wiring member 30. The size of the elastic press piece 55 reaching the holding surface 46f of the base body 46 may also be considered as a distance from a surface of the press body 54 facing the holding surface 46f to the holding surface 46f.

The counterpart locking part 52 is continuously formed with the press body 54 on a side opposite to the hinge 43.

The counterpart locking part 52 includes a locking hole 52h through which the through locking part 48 passes. In the present embodiment, the counterpart locking part 52 protrudes more than an outward surface of the press body 54. The locking hole 52h is formed to pass through the counterpart locking part 52 from the surface thereof on the side of the holding surface 46f toward the opposite side thereof. Since the through locking part 48 passes through the locking hole 52h, the locking convex part 48b is locked to an outward surface of the counterpart locking part 52.

The locking hole 52h includes an opening 52ha opened to the side of the base body 46 to receive the through locking part 48.

The counterpart locking part 52 includes a concave part 52g housing the leftover tongue piece 39 at a position adjacent to the opening 52ha. The concave part 52g is a part of the locking hole 52h spreading wider than an outer opening to which the locking convex part 48b is locked. Since the leftover tongue piece 39 is located closer to a side of the hinge 43 in relation to the through locking part 48 in the present embodiment, the concave part 52g is located adjacent to the side of the hinge 43 with respect to the opening 52ha.

Then, when the through locking part 48 is inserted into the locking hole 52h, the leftover tongue piece 39 is pressed away by the through locking part 48. Then, the leftover tongue piece 39 can enter the concave part 52g. Thus, the leftover tongue piece 39 hardly enters between the through locking part 48 and the locking hole 52h to interfere with the locking of the through locking part 48. The leftover tongue piece 39 hardly enters between the holding surface 46f and the press body 54 and interferes with contact of the press body 54 with the holding surface 46f. Thus, the through locking part 48 is can be smoothly locked to the counterpart locking part 52.

The leftover tongue piece 39 is preferably formed to have an extension length so as not to reach the locking convex part 48b. For example, the leftover tongue piece 39 is preferably formed to have a length smaller than a distance from the holding surface 46f to the locking convex part 48b.

The counterpart locking part 52 includes a guide surface 53g adjacent to the opening 52ha on a side opposite to the hinge 43. The guide surface 53g is formed in a surface directed to a side opposite to the hinge 43 as getting closer to outside from the opening 52ha.

Then, when the press part 50 is pivoted around the hinge 43 to be moved from the open position to the close position, the distal end part of the through locking part 48 has contact with the guide surface 53g. Then, the distal end part of the through locking part 48 is pressed to a side of the hinge 43 by the guide surface 53g. Accordingly, the locking convex part 48b is easily moved to the side of the hinge 43, and the through locking part 48 easily passes through the locking hole 52h.

The shape of the elastic press piece 55 is not limited to the above example. For example, the elastic press piece may have a shape curved into a J-like shape and protrudes from the elastic press piece toward the holding surface or a shape protruding in a zig-zag form. It is sufficient that the elastic press piece is elastically deformed so that the amount of protrusion from the press body can be changed.

### Example of Manufacturing Method

An example of a method of manufacturing the wiring member 20 is described.

The flat wiring member 30 and the flat wiring member holding member 40 are firstly prepared.

The through hole 38 is formed in the base member 32 of the flat wiring member 30. The leftover tongue piece 39 extends from a part of the peripheral edge of the through hole 38. The leftover tongue piece 39 is continuously formed with the peripheral edge of the through hole 38 at a part close to any side edge of the base member 32, and is separated from the base member 32 at the other part. For example, the leftover tongue piece 39 is continuously formed with the base member 32 at a part close to the side edge of the base member 32, and extends toward the center of the base member 32 in the width direction.

The position and number of the through holes 38 formed in the flat wiring member 30 are optionally set. For example, the through hole 38 is formed in a position to be held by the holding member 40 and a position corresponding to the number thereof.

In the holding member 40, the press part 50 is opened with respect to the holding base 44.

A part of the flat wiring member 30 to be held by the holding member 40 is disposed on the holding surface 46f of the holding member 40. For example, a part of the flat wiring member 30 outside the through hole 38 is disposed on the holding surface 46f. At this time, the through locking part 48 passes through the through hole 38. Then, the leftover tongue piece 39 is pressed by the through locking part 48 and is bended up. Any of the base member 32 and the cover 34 in the flat wiring member 30 may be directed to the side of the holding surface 46f.

Then, the press part 50 is pivoted around the hinge 43 to be pressed toward the holding base 44. Then, the distal end part of the through locking part 48 has contact with the guide surface 53g, and the through locking part 48 is bended to the side of the hinge 43.

Accordingly, the through locking part 48 hardly enters the locking hole 52h. Finally, the locking convex part 48b passes over the locking hole 52h, and is locked to the counterpart locking part 52 from a side opposite to the base member 32.

When the through locking part 48 passes through the counterpart locking part 52, the leftover tongue piece 39 enters the concave part 52g, thus hardly enters the locking hole 52h together with the through locking part 48. If the leftover tongue piece 39 enters the locking hole 52h together with the through locking part 48, prevented is elastic deformation of the through locking part 48 in the locking hole 52h. Thus, when the leftover tongue piece 39 enters the concave part 52g, the through locking part 48 is smoothly elastically deformed in the locking hole 52h, and can be smoothly locked to the counterpart locking part 52.

If the leftover tongue piece 39 is located closer to the side of the locking convex part 48b in relation to the through locking part 48, there is a possibility that the leftover tongue piece 39 intervenes between the through locking part 48 and the counterpart locking part 52 at the side of the locking convex part 48b. In this case, there is a possibility that a locking allowance of the locking convex part 48b with respect to the counterpart locking part 52 decreases. When the leftover tongue piece 39 is located on the opposite side of the through locking part 48 from the locking convex part 48b, the leftover tongue piece 39 hardly interferes with the locking of the locking convex part 48b and the counterpart locking part 52.

When the press part 50 gets close to the holding base 44, the elastic press piece 55 has contact with the flat wiring member 30. As the press part 50 gets closer to the holding base 44, the elastic press piece 55 is elastically deformed to enter the side of the through opening 54h. That is to say, as the press part 50 gets closer to the holding base 44, the elastic press piece 55 is pressed toward the through opening 54h by the flat wiring member 30, and the amount of protrusion of the elastic press piece 55 with respect to the press body 54 decreases.

Herein, the elastic press piece 55 includes an intermediate inclination part 55c inclined with respect to the horizontal facing part 54b of the press body 54 in a natural state. When the distal end 55b of the elastic press piece 55 is pressed toward the inner side of the through opening 54h, a posture of the intermediate inclination part 55c gets close to a horizontal state with respect to the horizontal facing part 54b. Thus, the distal end 55b gets close to the through locking part 48. Since the distal end 55b of the elastic press piece 55 includes the curved surface 55f, the distal end 55b can be deformed in the direction of retracting from the holding surface 46f while smoothly sliding on the upper surface of the flat wiring member 30. A part of the flat wiring member 30 pressed by the elastic press piece 55 is hardly pressed to the side of the through locking part 48, and a wrinkle, for example, hardly occurs in the base member 32 and the cover 34.

An interval d1 corresponding to a thickness of a sandwiching part of the flat wiring member 30 is provided between the distal end 55b of the elastic press piece 55 and the holding surface 46f while the locking convex part 48b is locked to the counterpart locking part 52. In this state, the protrusion length of the elastic press piece 55 with respect to the press body 54 has a size obtained by subtracting a thickness d1 of the sandwiching part of the flat wiring member 30 from a distance from the press body 54 to the holding surface 46f (equal to the natural protrusion length L0, herein). In this state, the elastic press piece 55 presses the flat wiring member 30 toward the holding surface 46f.

The thickness of the sandwiching part of the flat wiring member 30 is assumed to be changed. For example, the holding member 40 is assumed to hold two flat wiring members 30 stacked to each other. In this case, two combinations of the base member 32 and the cover 34 are disposed between the holding base 44 and the press part 50, and a thickness d2 thereof is larger than the thickness d1 described above.

In this case, the elastic press piece 55 is elastically deformed with a larger degree, and an interval d2 corresponding to a thickness of a sandwiching part of two flat wiring members 30 is provided between the distal end 55b of the elastic press piece 55 and the holding surface 46f while the locking convex part 48b is locked to the counterpart locking part 52.

When the cover 34 of the flat wiring member 30 is omitted, the elastic press piece 55 is elastically deformed in accordance with the thickness of a target part of one or the plurality of flat wiring members 30 to be sandwiched even when the larger number of the flat wiring members 30 are stacked, and the flat wiring member 30 can be pressed toward the holding surface 46f.

The flat wiring member 30 is sandwiched between the holding surface 46f and the elastic press piece 55, thus is firmly held. Since the flat wiring member 30 is pressed against the holding surface 46f by the elastic press piece 55, the flat wiring member 30 is held in a constant position based on the holding surface 46f.

### <Effect etc.>

According to the wiring module 20 and the flat wiring member holding member 40 having the above configurations, the elastic press piece 55 is deformed in accordance with the thickness of the flat wiring member 30, and elastically deforms the flat wiring member 30 toward the base body 46. Thus, the flat wiring member 30 can be firmly pressed against the base body 46 and held regardless of the thickness of the flat wiring member 30.

The through locking part 48 is locked to the counterpart locking part 52 while passing through the flat wiring member 30, and sandwiches the flat wiring member 30 between the base body 46 and the press part 50. Thus, the flat wiring member 30 can be held regardless of the width and the shape of the flat wiring member 30, for example. Thus, the flat wiring member holding member 40 is not a dedicated component holding the flat wiring member 30 having a predetermined width, but can be used as a general-purpose component holding the flat wiring member 30 having various widths and various shapes. A design regarding the holding member 40 can be easily diverted as a constituent part of wiring support components having various shapes as a configuration for holding various parts of the flat wiring member 30. Thus, even when a shape such as a width of the flat wiring member 30 is changed, the flat wiring member 30 can be easily held.

The elastic press piece 55 is disposed in the position closer to the edge of the flat wiring member 30 than the through locking part 48 is. Thus, the flat wiring member 30 can be firmly pressed toward the base body 46 at the position close to the edge thereof. Accordingly, the side edge of the flat wiring member 30 is hardly peeled, for example.

Since the elastic press piece 55 includes the intermediate inclination part 55c extending from the press body 54 with a larger degree as getting closer to the distal end 55b from the base end 55a, the flat wiring member 30 can be pressed toward the base body 46 at a part of the elastic press piece 55 close to the through locking part 48, and can be firmly held.

The flat wiring member 30 is pressed against the holding surface 46f by the elastic press piece 55 at the part close to the through hole 38. Moreover, the leftover tongue piece 39 is located between the through locking part 48 and the elastic press piece 55. Thus, the base end of the leftover tongue piece 39 is pressed near the holding surface 46f, and the leftover tongue piece 39 hardly enters the side of the distal end of the through locking part 48. Thus, the leftover tongue piece 39 hardly interferes with the locking of the through locking part 48 and the counterpart locking part 52.

Since the base body 46 and the press part 50 are connected to each other by the hinge 43, the base body 46 and the press part 50 can be integrally handled easily.

Since a part of the elastic press piece 55 having contact with the flat wiring member 30 includes the curved surface 55f formed into the curved surface, the curved surface 55f can smoothy slide on the flat wiring member 30 when the elastic press piece 55 presses the flat wiring member 30. Accordingly, the elastic press piece 55 can be elastically deformed smoothly. The flat wiring member 30 is hardly pressed to the direction along the holding surface 46f, thus is hardly loosened.

The press body 54 includes the through opening 54h, and the elastic press piece 55 is located in the through opening 54h in a plan view. Thus, the elastic press piece 55 can be elastically deformed using a space in the through opening 54h. Accordingly, a space in which the elastic press piece 55 can be deformed is easily ensured while the flat wiring member holding member 40 is thinned. That is to say, a holdable range of the thickness of the flat wiring member 30 can be increased while the holding member 40 is downsized.

When the natural protrusion length LO of the elastic press piece 55 with respect to the press body 54 has a size such that the elastic press piece 55 reaches the holding surface 46f of the base body 46 while the through locking part 48 is locked to the counterpart locking part 52, the elastic press piece 55 can press the flat wiring member 30 against the base body 46 more reliably.

The fixing part 60 protrudes from the base body 46, and is fixed to the fixation target 10. For example, when the fixing part 60 is inserted into the fixing hole 12 and fixed thereto, the flat wiring member 30 is held at the constant position with respect to the fixation target.

The holding member 40 can easily fix the flat wiring member 30 including the base member 32 and the plurality of wire-like transmission members 36, for example. At this time, since the elastic press piece 55 presses the flat wiring member 30, the flat wiring member 30 is held at a stable position in the thickness direction.

The base member 32 and the press part 50 sandwich and hold the region outside the plurality of wire-like transmission members 36 in the base member 32, thus can hold the flat wiring member 30. Since the wire-like transmission members 36 needs not be sandwiched, the holding part can be thinned, and local force needs not be acted on the wire-like transmission member 36.

It is also applicable that a part of the flat wiring member 30 partially protrudes outside, and the part protruding outside is held by the holding member 40.

### Embodiment 2

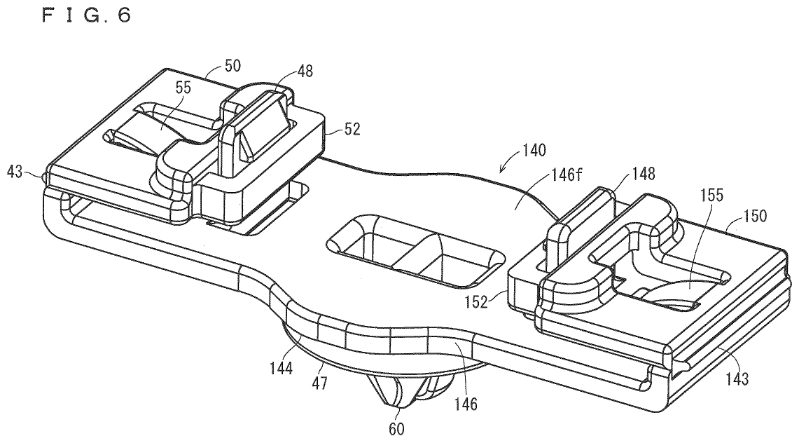

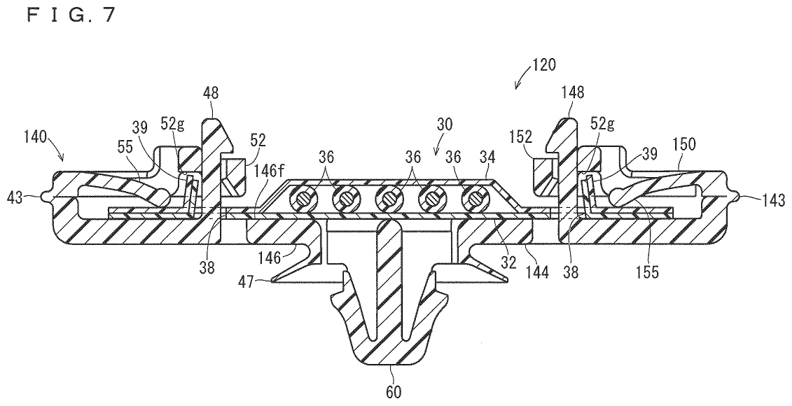

A flat wiring member holding member 140 and a wiring module 120 according to an embodiment 2 are described. FIG. 6 is a perspective view illustrating the flat wiring member holding member 140. FIG. 7 is a cross-sectional view illustrating the wiring module 120. In the description of the present embodiment, the same reference numerals are assigned to the similar constituent elements described above, and the description thereof will be omitted.

The flat wiring member holding member 140 includes holding base 144, the press part 50, and additional press part 150.

The holding base 144 is formed into an elongated shape. The holding base 44 includes a base body 146, the through locking part 48, and an additional through locking part 148.

The base body 146 is formed into an elongate plate-like shape, and one main surface thereof is a holding surface 146f. The through locking part 48 is located closer to one end of the base body 146 in a longitudinal direction. The press part 50 is openably and closably supported on one end part of the base body 146 in the longitudinal direction via the hinge 43. The press part 50 may not have the inclination part 54a.

Thus, in the manner similar to the embodiment 1, one side part of the flat wiring member 30 is sandwiched and held between one end part of the base body 146 and the press part 50.

The additional through locking part 148 protrudes from the other end of the holding base 144 in the longitudinal direction. The additional through locking part 148 has the same configuration as the through locking part 48.

The flat wiring member holding member 140 further includes an additional press part 150 sandwiching the flat wiring member 30 with a part of the base body 146 close to the other end in the longitudinal direction. The additional press part 150 includes a counterpart additional locking part 152 to which the additional through locking part 148 can be locked. The additional press part 150 described above has the same configuration as the press part 50, and the counterpart additional locking part 152 has the same configuration as the counterpart locking part 52. The additional press part 150 is openably and closably supported on the other end part of the base body 146 in the longitudinal direction via the hinge 143.

As described in the embodiment 1, the press part 50 includes the elastic press piece 55. The additional press part 150 includes the additional elastic press piece 155 in the manner similar to the press part 50.

The additional through locking part 148 and the additional press part 150 including the counterpart additional locking part 152 and the additional elastic press piece 155 may have a plane-symmetrical shape with respect to the through locking part 48 and the press part 50 including the counterpart locking part 52 and the elastic press piece 55 based on a surface crossing a center of the base body 146 in the longitudinal direction as a symmetric surface.

The fixing part 60 protrudes from an intermediate part of the base body 146 in a longitudinal direction to a side opposite to the holding surface 146f. Thus, an intermediate part of the holding base 144 can be supported on the fixation target 10 by the fixing part 60.

The intermediate part of the flat wiring member 30 in the longitudinal direction is disposed on the holding surface 146f of the base body 146. At this time, the flat wiring member 30 has a posture that the longitudinal direction of the flat wiring member 30 is perpendicular to the longitudinal direction of the base body 146. A part of the flat wiring member 30 located on outer side of the plurality of wire-like transmission members 36 is disposed on one end part of the base body 146 in the longitudinal direction, and a part of the flat wiring member 30 located on the other outer side of the plurality of wire-like transmission members 36 is disposed on the other end part of the base body 146 in the longitudinal direction. The plurality of wire-like transmission members 36 are disposed between the through locking part 48 and the additional through locking part 148.

Then, when the through locking part 48 is pivoted from the open position toward the close position around the hinge 43, as described in the embodiment 1, one side part of the flat wiring member 30 in the width direction is sandwiched between one end part of the base body 146 in the longitudinal direction and the press part 50. When the additional through locking part 148 is pivoted from the open position toward the close position around the hinge 143, the other side part of the flat wiring member 30 in the width direction is sandwiched between the other end part of the base body 146 in the longitudinal direction and the additional press part 150 in the manner similar to the above description. The elastic press piece 55 and the additional elastic press piece 155 elastically press both side parts of the flat wiring member 30 toward the holding surface 146f at both ends of the base body 146 in the longitudinal direction. Thus, both side parts of the flat wiring member 30 are held along the holding surface 46f, and the intermediate part of the flat wiring member 30 in the width direction is also held along the holding surface 46f. Thus, the flat wiring member 30 is held on the holding surface 46f in a stable posture.

Focusing on the configuration of the side of one end part of the base body 146 in the longitudinal direction and the configuration of the side of the other end part of the base body 146 in the longitudinal direction, the flat wiring member 30 can be held regardless of the a width and a shape, for example, of the flat wiring member 30. For example, the width of the flat wiring member 30 can be changed only by changing a design of a length of the base body 146 without changing shapes of the press part 50, the through locking part 48, the additional press part 150, and the additional through locking part 148. Thus, even when a shape such as a width of the flat wiring member 30 is changed, the flat wiring member 30 can be easily held by changing the length of the base body 146.

The flat wiring member 30 can be firmly held at both ends of the base body 146 in the longitudinal direction.

### Modification Example

It is also applicable that in the embodiment 1 or the embodiment 2, the through locking part is formed in the press part, and the locking hole which the through locking part passes through and is locked to is formed in the holding base.

Each configuration described in each embodiment and modification example described above can be appropriately combined as long as they are not contradictory.

While the disclosure has been shown and described in detail, the foregoing description is in all aspects illustrative and not restrictive. It is therefore understood that numerous modifications and variations can be devised.

What is claimed is:

1. A flat wiring member holding member holding a flat wiring member, comprising:
a holding base including a base body and a locking part; and
a press part including a press body disposed to face the base body and a counterpart locking part locked to the locking part, wherein
the flat wiring member is disposed between the base body and the press body while the locking part is locked to the counterpart locking part, and
the press part includes an elastic press piece protruding to a side of the base body from the press body to elastically press the flat wiring member toward the base body.

2. The flat wiring member holding member according to claim 1, wherein
the locking part is a through locking part protruding from the base body, and
the through locking part is locked to the counterpart locking part while passing through the flat wiring member, and the flat wiring member is disposed between the base body and the press part.

3. The flat wiring member holding member according to claim 2, wherein
the elastic press piece is disposed in a position closer to an edge of the flat wiring member than the through locking part is.

4. The flat wiring member holding member according to claim 2, wherein
the elastic press piece includes a base end continuously formed with the press body and a distal end located closer to the through locking part than the base end is, and
the elastic press piece includes a part extending to protrude from the press body with a larger degree as getting closer to the distal end from the base end.

5. The flat wiring member holding member according to claim 1, further comprising
a hinge openably and closably connecting the base body and the press part.

6. The flat wiring member holding member according to claim 1, wherein
a part of the elastic press piece having contact with the flat wiring member is formed into a curved shape.

7. The flat wiring member holding member according to claim 1, wherein
the press body includes a through opening, and
the elastic press piece is located inside the through opening in a plan view.

8. The flat wiring member holding member according to claim 1, wherein
a natural protrusion length of the elastic press piece with respect to the press body is a length such that the elastic press piece reaches a holding surface of the base body while the locking part is locked to the counterpart locking part.

9. The flat wiring member holding member according to claim 1, wherein
a fixing part fixed to a fixation target protrudes from the base body.

10. A wiring module, comprising:
the flat wiring member holding member according to claim 1; and
a flat wiring member, wherein
the elastic press piece presses a part of the flat wiring member located between the base body and the press body toward the base body.
